(19) United States
(12) Patent Application Publication
(10) Pub. No.: US 2017/0298978 A1
(43) Pub. Date: Oct. 19, 2017

(54) FLAT-FORMED BOLT

(71) Applicant: Teng-Fu Hu, Taichung City (TW)

(72) Inventor: Teng-Fu Hu, Taichung City (TW)

(21) Appl. No.: 15/097,783

(22) Filed: Apr. 13, 2016

(51) Int. Cl. F16B 35/04; F16B 23/00; F16B 27/00; F16B 35/06

(52) U.S. Cl. CPC F16B 35/041; F16B 35/06; F16B 23/00; F16B 27/00

(57) ABSTRACT

A flat-formed bolt is divided into an operating portion and a screwing portion, wherein the operating portion and the screwing portion are plat-formed and co-axially correspond to each other. The screwing portion has two opposite sides each formed with a series of teeth, wherein the two series of teeth are staggered relative to each other and each tooth vertically corresponds to an axis of the operating portion and the screwing portion such that the screwing portion can be screwed into a threaded hole previously defined in a work piece.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a bolt, and more particularly to a flat-formed bolt.

2. Description of Related Art Including Information Disclosed Under 37 CFR 1.97 and 37 CFR 1.98

A bolt is a common element for assembling two work pieces by using male thread female thread. However, an enlarged head and a threaded rod centrally and integrally extending from the enlarged head are immutable structures.

However, the conventional bolt in accordance with the prior art has some disadvantages as follows. The threaded rod of the conventional bolt is complementally received in a threaded hole after being screwed into the threaded hole for providing a high torsion. However, a high torsion may not be always necessary such that the high torsion sometimes causes a surplus quality. The conventional bolts are cheap, however, the manufacturing process may be simplified, the production capacity may be raised and the operation becomes more convenient when changing the immutable structures of the conventional bolts.

The present invention has arisen to mitigate and/or obviate the disadvantages of the conventional bolts.

### BRIEF SUMMARY OF THE INVENTION

The main objective of the present invention is to provide an improved bolt that has a flat-formed structure.

To achieve the objective, the flat-formed bolt in accordance with the present invention is divided into an operating portion and a screwing portion, wherein the operating portion and the screwing portion are plat-formed and co-axially correspond to each other. The screwing portion has two opposite sides each formed with a series of teeth, wherein the two series of teeth are staggered relative to each other and each tooth vertically corresponds to an axis of the operating portion and the screwing portion such that the screwing portion can be screwed into a threaded hole previously defined in a work piece.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is a perspective view of a first embodiment of a flat-formed bolt in accordance with the present invention.

FIG. 1A is a side plan view of the flat-formed bolt in FIG. 1.

FIG. 2 is a perspective view of a second embodiment of the flat-formed bolt in accordance with the present invention.

FIG. 3 is a side plan view of the flat-formed bolt in FIG. 2.

FIG. 4 is a perspective view of a third embodiment of the flat-formed bolt in accordance with the present invention.

FIG. 5 is an operational view of the flat-formed bolt in FIG. 1.

FIG. 6 is a cross-sectional view of the flat-formed bolt in FIG. 1 after being screwed into work pieces.

FIG. 7 is a cross-sectional view of the flat-formed bolt in FIG. 2 after being screwed into work pieces.

FIG. 8 is a cross-sectional view of the flat-formed bolt in FIG. 4 after being screwed into work pieces.

FIG. 9 is another cross-sectional view of the flat-formed bolt in FIG. 4 after being screwed into work pieces.

FIG. 10 is a schematic view of a flat-formed bolt in accordance with the present invention.

FIG. 11 is a front plan view of the flat-formed bolts in FIG. 1 when being laterally connected by connecting elements.

FIG. 12 top plan view of the flat-formed bolt in FIG. 1 when being formed with ribs.

### DETAILED DESCRIPTION OF THE INVENTION

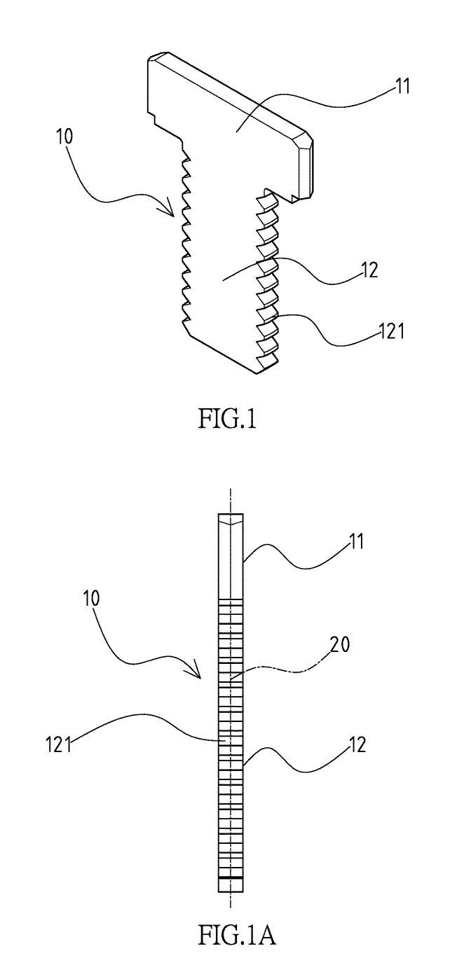

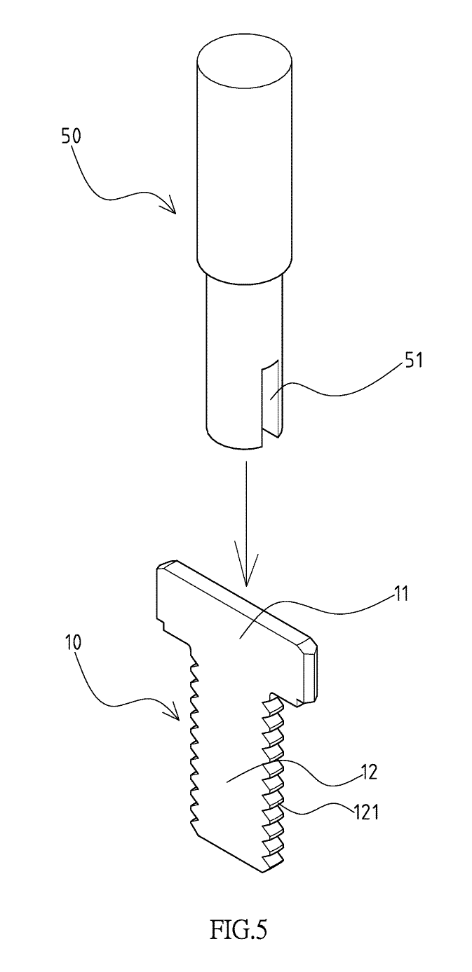

Referring to the drawings and initially to FIGS. 1, 1A and 6, a flat-formed bolt 10 in accordance with the present invention is divided into an operating portion 11 and a screwing portion 12, wherein the operating portion 11 and the screwing portion 12 are plat-formed and co-axially correspond to each other. The screwing portion 12 has two opposite sides each formed with a series of teeth 121, wherein the two series of teeth 121 are staggered relative to each other and each tooth 121 vertically corresponds to an axis of the operating portion 11 and the screwing portion 12 such that the screwing portion 12 can be screwed into a threaded hole 61 previously defined in a work piece 60. The screwing portion 12 vertically and integrally extends from the operating portion 11 and forms a T-shaped structure with the operating portion 11. In the preferred embodiment of the present invention, the operating portion 11 has a thickness equal to that of the screwing portion 12 for simplifying the manufacturing processes of the flat-formed bolt 10 in accordance with the present invention. With reference to FIG. 5, a driver 50 is provided to drive the flat-formed bolt 10 in accordance with the present invention, wherein the driver 50 has a groove 51 diametrically defined in a distal end thereof. When rotating the flat-formed bolt 10 in accordance with the present invention, a middle portion of the operating portion 11 is engaged into the groove 51 such that the screwing portion 12 can be rotated with the operating portion 11 and screwed into the threaded hole 61 in the work piece 60 for providing a fastening effect.

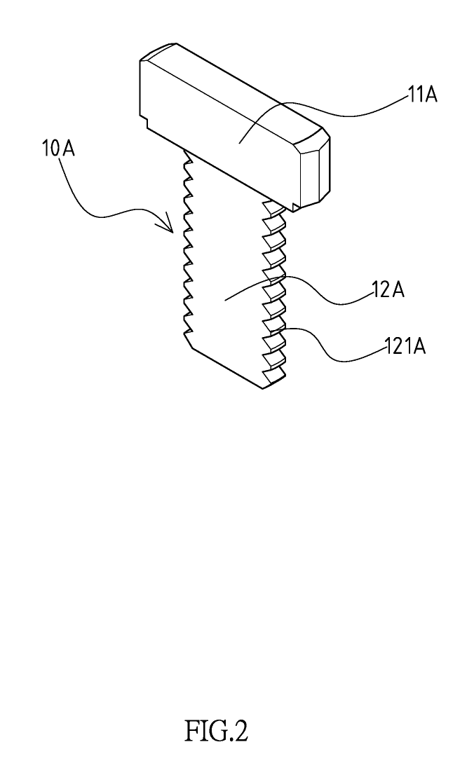

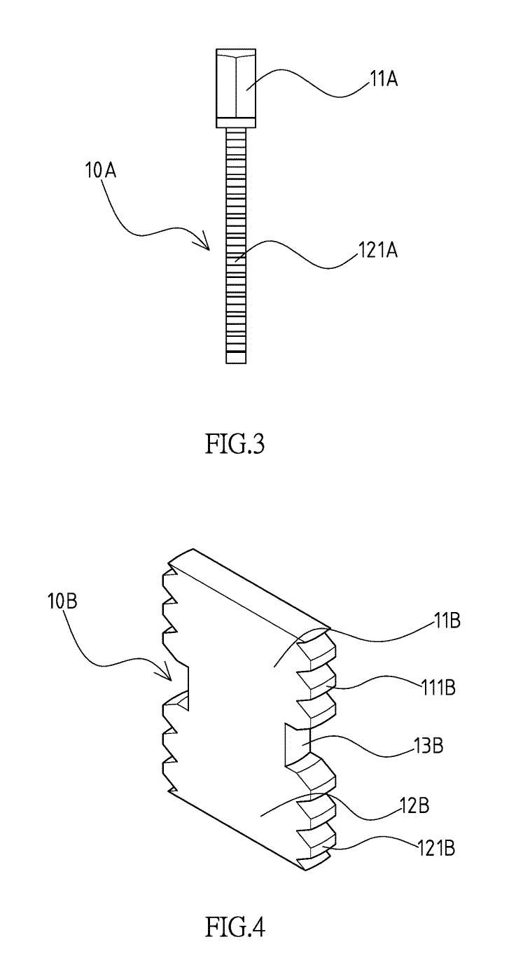

With reference to FIGS. 2 and 3 that show a second embodiment of the flat-formed bolt 10A in accordance with the present invention, in this embodiment, the flat-formed bolt 10A is divided into an operating portion 11A and a screwing portion 12A, wherein the operating portion 11A and the screwing portion 12A are plat-formed and co-axially correspond to each other. The screwing portion 12A has two opposite sides each formed with a series of teeth 121A, wherein the two series of teeth 121A are staggered relative to each other and each tooth 121A vertically corresponds to an axis of the operating portion 11A and the screwing portion 12A. The screwing portion 12A vertically and integrally extends from the operating portion 11A and forms a T-shaped structure with the operating portion 11A. In this embodiment, the operating portion 11A has a thickness greater than that of the screwing portion 12A for strengthening the structure of the operating portion 11A. The operating method of this embodiment is the same as that of the first embodiment, as described above, wherein a middle portion of the operating portion 11A is engaged into the groove 51 such that the screwing portion 12A can be rotated with the operating portion 11A and screwed into the threaded hole 61 in the work piece 60 for providing a fastening effect.

With reference to FIG. 4 that shows a third embodiment of the flat-formed bolt 10B in accordance with the present invention, in this embodiment, the flat-formed bolt 10B is divided into an operating portion 11B and a screwing portion 12B, wherein the operating portion 11B and the screwing portion 12B are plat-formed and co-axially correspond to each other. The operating portion 11B has two opposite sides each formed with a series of teeth 111B, wherein the two series of teeth 111B of the operating portion 11B are staggered relative to each other and each tooth 111B vertically corresponds to an axis of the operating portion 11B and the screwing portion 12B. The screwing portion 12B has two opposite sides each formed with a series of teeth 121B, wherein the two series of teeth 121B are staggered relative to each other and each tooth 121B vertically corresponds to an axis of the operating portion 11B and the screwing portion 12B such that the operating portion 11B and the screwing portion 12B can be screwed into a threaded hole 61 previously defined in a work piece 60. In the preferred embodiment of the present invention, the operating portion 11B has a width equal to that of the screwing portion 12B. Further with reference to FIG. 5, the operating method of this embodiment is the same as that of the first embodiment, as described above, wherein a middle portion of the operating portion 11A/screwing portion 12B is engaged into the groove 51 such that the screwing portion 12B/operating portion 11B can be rotated with the operating portion 11A/screwing portion 12B and screwed into the threaded hole 61 in the work piece 60 for providing a fastening effect.

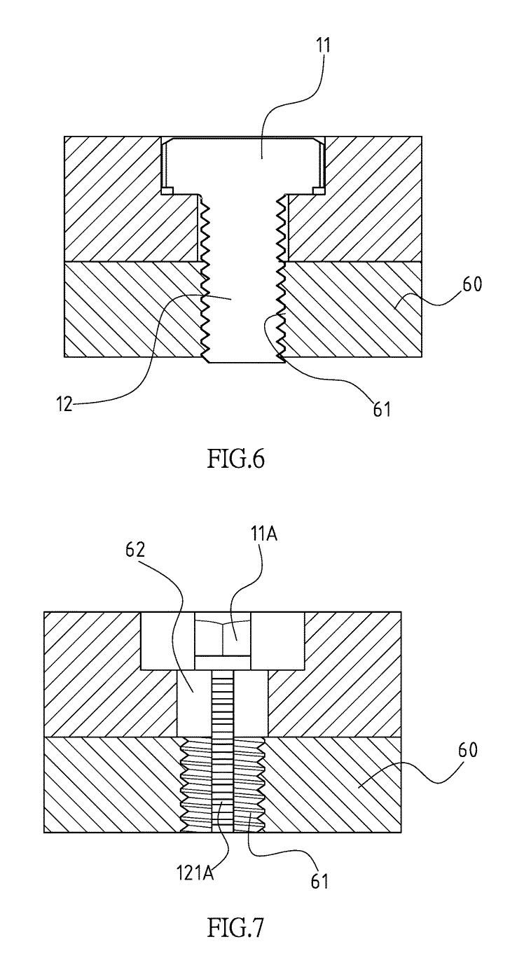

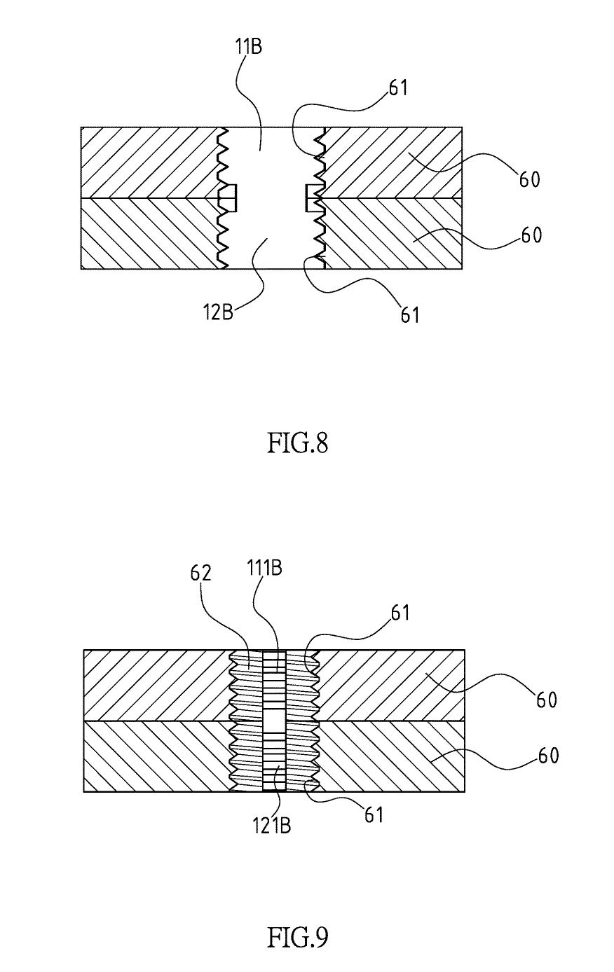

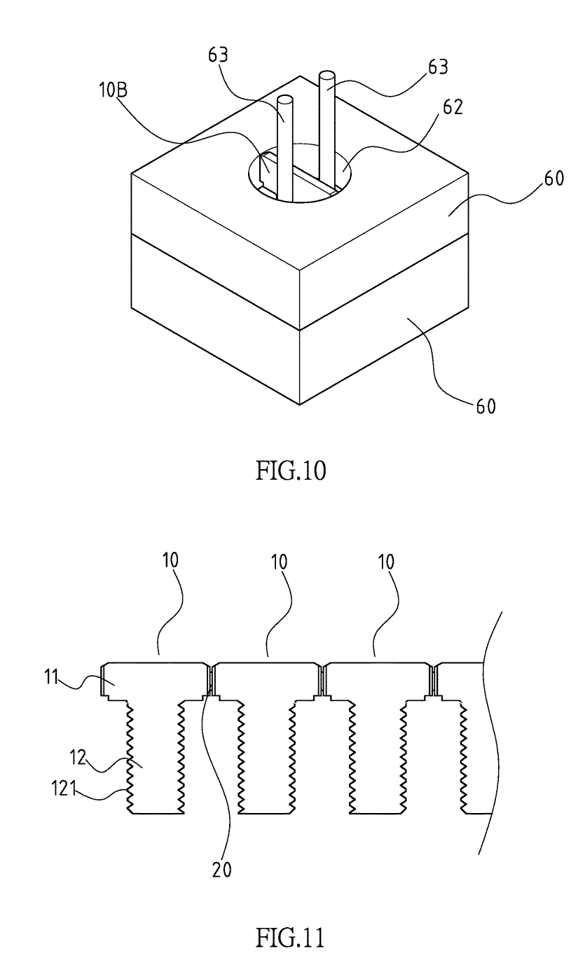

With reference to FIGS. 7, 9 and 10, for a smooth operation, the threaded hole 61 must be round. The operating portion 11/11A/11B and the screwing portion 12/12A/12B are plat-formed such that the threaded hole 61 is divided into two tunnels 62 after the flat-formed bolt 10/10A/10B being screwed into the threaded hole 61 that extending through the work piece 60. Consequently, the two tunnels 62 can be used for electric wiring, that's the wires 63 respectively extend through a corresponding one of the two tunnels 62 without defining wiring holes. In addition, the wires 63 are hidden in the work piece 60 for preventing the wires 63 from being oxidized due to sunlight and broken due to rat bite. As a result, the use life of the wire is lengthened.

With reference to FIG. 11, the present invention is a plat-formed structure such that the thickness can be reduced when the torsion requirement is low for manufacturing by punch. Consequently, the operating portions 11 of every two adjacent flat-formed bolts 10 can be connected by a connecting element 20, wherein the connecting element 20 is a pre-broken structure. The connected flat-formed bolts 10 are easily to be carried and have a same direction for a convenient operation. When rotating the connected flat-formed bolt 10 in accordance with the present invention, a middle portion of the operating portion 11 is engaged into the groove 51 and the connecting element 20 is broken when the engaged flat-formed blot 10 is wrenched from forming a single one and rotating to be screwed into the threaded hole 61. As usual, the distal end of the driver 50 is magnetized such that the wrenched single flat-formed bolt 10 would not be detached from the driver 50. Certainly, the second embodiment of the flat-formed bolt 10A also can be connected by the connecting element 20.

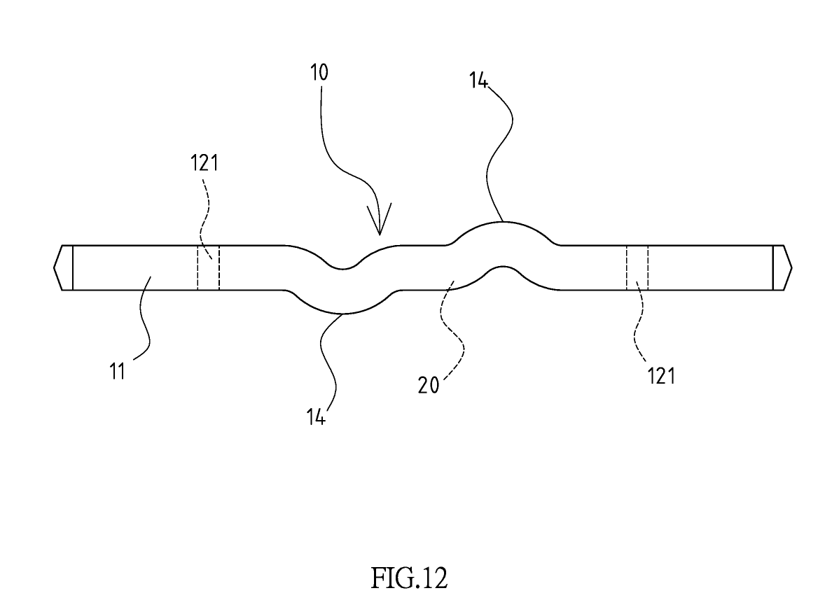

With reference to FIG. 12, the preferred embodiments of the present invention are flat-formed structures and may have a relative weak strength in some conditions. For mitigate and/or obviate the problem, at least one face of the flat-formed bolt 10 has a rib 14 longitudinally formed thereon for strengthening the structure of the flat-formed bolt 10. In the preferred embodiment of the present invention, each face of the flat-formed bolt 10 has a rib 14 formed thereon. In addition, the rib 14 in this embodiment can be also from on at least one side of the screwing portion 12A of the second embodiment as described above or the at least one side of the flat-formed bolt 10B of the third embodiment.

As described above, the flat-formed bolt 10/10A/10B in accordance with the present invention change the manufacturing processes of the conventional bolts by the flat-formed structure. Consequently, the productivity of the bolts is promoted and the manufacturing cost is reduced when a high torsion is unnecessary. In addition, the connected flat-formed bolts 10 reduced the storage space and can be conveniently operated one after one. Furthermore, the screwed flat-formed bolt 10/10A/10B divides the threaded hole 61 into two tunnels 62 for electric wiring without drilling holes in the work piece 60.

Although the invention has been explained in relation to its preferred embodiment, it is to be understood that many other possible modifications and variations can be made without departing from the spirit and scope of the invention as hereinafter claimed.

I claim:

1. A flat-formed bolt divided into an operating portion and a screwing portion, wherein the operating portion and the screwing portion are plat-formed and co-axially correspond to each other, and the operating portion and the screwing portion integrally formed with each other, the screwing portion having two opposite sides each formed with a series of teeth, wherein the two series of teeth are staggered relative to each other and each tooth vertically corresponds to an axis of the operating portion and the screwing portion such that the screwing portion can be screwed into a threaded hole previously defined in a work piece.

2. The flat-formed bolt as claimed in claim 1, wherein each tooth on the screwing portion vertically corresponds to an axis of the operating portion and the screwing portion.

3. The flat-formed bolt as claimed in claim 1 further including two faces, wherein at least one face has a rib formed thereon for strengthening the structure of the flat-formed bolt.

4. The flat-formed bolt as claimed in claim 2 further including two faces, wherein at least one face has a rib formed thereon for strengthening the structure of the flat-formed bolt.

5. The flat-formed bolt as claimed in claim 1, wherein the structures of the operating portion and the screwing portion correspond to each other.

6. The flat-formed bolt as claimed in claim 2, wherein the structures of the operating portion and the screwing portion correspond to each other.

7. The flat-formed bolt as claimed in claim 3, wherein the structures of the operating portion and the screwing portion correspond to each other.

8. The flat-formed bolt as claimed in claim 4, wherein the structures of the operating portion and the screwing portion correspond to each other.

9. The flat-formed bolt as claimed in claim 1, wherein the operating portions of every two adjacent flat-formed bolts are connected by a connecting element and the connecting element is a pre-broken structure.

10. The flat-formed bolt as claimed in claim 2, wherein the operating portions of every two adjacent flat-formed bolts are connected by a connecting element and the connecting element is a pre-broken structure.

11. The flat-formed bolt as claimed in claim 3, wherein the operating portions of every two adjacent flat-formed bolts are connected by a connecting element and the connecting element is a pre-broken structure.

12. The flat-formed bolt as claimed in claim 4, wherein the operating portions of every two adjacent flat-formed bolts are connected by a connecting element and the connecting element is a pre-broken structure.

13. The flat-formed bolt as claimed in claim 1, wherein the screwing portion integrally and co-axially extends from the operating portion and forms a T-shaped structure with the operating portion.

14. The flat-formed bolt as claimed in claim 2, wherein the screwing portion integrally and co-axially extends from the operating portion and forms a T-shaped structure with the operating portion.

15. The flat-formed bolt as claimed in claim 3, wherein the screwing portion integrally and co-axially extends from the operating portion and forms a T-shaped structure with the operating portion.

16. The flat-formed bolt as claimed in claim 4, wherein the screwing portion integrally and co-axially extends from the operating portion and forms a T-shaped structure with the operating portion.

17. The flat-formed bolt as claimed in claim 9, wherein the screwing portion integrally and co-axially extends from the operating portion and forms a T-shaped structure with the operating portion.

18. The flat-formed bolt as claimed in claim 10, wherein the screwing portion integrally and co-axially extends from the operating portion and forms a T-shaped structure with the operating portion.

19. The flat-formed bolt as claimed in claim 11, wherein the screwing portion integrally and co-axially extends from the operating portion and forms a T-shaped structure with the operating portion.

20. The flat-formed bolt as claimed in claim 12, wherein the screwing portion integrally and co-axially extends from the operating portion and forms a T-shaped structure with the operating portion.
